(19) United States
(12) Patent Application Publication
(10) Pub. No.: US 2005/0083680 A1
(43) Pub. Date: Apr. 21, 2005

(54) Illuminable writing instrument

(76) Inventor: Ve-Chung Hui, Hong Kong (HK)

Correspondence Address: Raymond Y. Chan, Suite 128, 108 N. Ynez Ave., Monterey Park, CA, 91754, US

(21) Appl. No.: 10/688,270

(22) Filed: Oct. 20, 2003

(51) Int. Cl. B43K 29/10

(52) U.S. Cl. 362/118

(57) ABSTRACT

An illuminable writing instrument includes a writing unit holder to receive a writing unit, and an illumination arrangement including a light dispersing cone having a cone vertex supported within the writing unit holder, an illuminator supported within the receiving cavity at a position right above the cone vertex of the light dispersing cone, and a control switch arranged to activate the illuminator for providing an illuminating effect towards the cone vertex of the light dispersing cone, such that the light dispersing cone is adapted for vividly dispersing the illuminating effect throughout the writing unit holder.

### BACKGROUND OF THE PRESENT INVENTION

1. Field of Invention

The present invention relates to a writing instrument, and more particularly to an illuminable writing instrument which comprises an illumination arrangement for providing an enhanced illuminating effect to the writing instrument so as to not only enhance the aesthetic appearance of the writing instrument but also facilitate the practical use thereof.

2. Description of Related Arts

Pen is a kind of writing instrument that comprises a hollow pen holder and an ink cartridge tube disposed along the pen holder. Generally, there are two types of pen, namely a mechanical pen and a disposable pen that the ink cartridge tube is irreplaceable such that the disposable pen must be thrown away when the ink of the ink cartridge tube is used up.

Accordingly, the ink cartridge tube is replaceable for the mechanical pen, wherein the mechanical pen further comprises an actuating unit provided on the pen holder to move the ink cartridge tube between an operation position and a storage position, wherein at the operation position, a writing point of the ink cartridge tube is pushed out of an end of the pen holder and at the storage position, the writing end of the ink cartridge tube is received within the pen holder.

In order to enhance the attraction of the pen, the pen, as disclosed in the U.S. Pat. No. 6,099,185, further comprises an illumination unit operatively incorporated with the pen holder to provide an enhanced illuminating effect for the pen. However, such illuminating pen has several drawbacks.

Due to the limited size of the pen, when the illumination unit is mounted at the tail end of the pen holder, the length of the pen holder must be substantially shortened. In other words, the size of the ink cartridge tube must be reduced to fit into the pen holder. Therefore, less amount of ink can be filled in the ink cartridge tube so as to shorten the service life span of the pen and highly increase the maintenance cost of the pen to refill the ink cartridge tube.

Another drawback is that, in order to enhance the conduction of light emitted by the illumination unit through entire pen holder, the pen holder is made up of a considerable mass of transparent material, which substantially increases the weight of the pen. Writing with a heavy pen is not efficient and can easily damage the wrists of users. Furthermore, the heat dissipated by the illumination unit is easily conducted to the user since the pen holder is made of a solid mass of transparent material, which will cause discomfort to the user if the pen is used for a prolonged period of time.

In addition, the illumination unit comprises a switch to activate the LED which results in the illumination of the illumination unit to provide the illuminating effect for the pen. However, the actuation of the illumination unit is independent that the pen holder must incorporate with another mechanism to actuate the ink cartridge tube. Therefore, the user may have to perform two different actions to switch on the illumination unit and actuate the ink cartridge tube to its operation position individually.

Furthermore, such illuminating pen discloses that the illumination unit can be detached from the pen holder to function as a flashlight. However, in accordance with the structural design, the illuminating pen can be simply considered as a flashlight detachably mounted to a regular mechanical pen since the lighter requires two individual actuations to operate the illumination unit and the ink cartridge tube respectively.

### SUMMARY OF THE PRESENT INVENTION

A main object of the present invention is to provide an illuminable writing instrument which comprises an illumination arrangement for providing an enhanced illuminating effect to the writing instrument so as to not only enhance the aesthetic appearance of the writing instrument but also facilitate the practical use thereof.

Another object of the present invention is to provide an illuminable writing instrument that can be actuated by a single operation, wherein the ink cartridge tube is stored inside the writing unit holder in a writing position requiring no actuation. This allows the illuminable writing instrument to perform normal writing functions without the need to operate the illuminable arrangement, so as to provide a longer life span of the illuminable arrangement.

Another object of the present invention is to provide an illuminable writing instrument wherein the writing unit holder is constructed in such a manner that the light emitted by the illuminable unit is conducted to the entire writing unit holder and to the environment without having to construct the writing unit holder with a solid mass of transparent material, so as to reduce the overall weight of the writing instrument and to provide better comfort to the user.

Another object of the present invention is to provide an illuminable writing instrument, wherein a plurality of light guiding channels are formed on the writing unit holder so that light emitted by the illuminable unit is conducted throughout the entire writing unit holder with the guide of the light guiding channels, so as to reduce the number of LED required to produce the same illuminating effect, and to enhance the illuminating effect of the illuminable unit.

Another object of the present invention is to provide an illuminable writing instrument, wherein the illumination arrangement is adapted to be incorporated with all kinds of conventional ink cartridge tubes, so as to allow users to reuse the writing unit holder without the need to look for ink cartridge tubes of special sizes.

Another object of the present invention is to provide an illuminable writing instrument, wherein a stopper incorporated with the ink cartridge tube is adapted to the writing unit holder, wherein the ink cartridge tube is fixed inside the writing unit holder by two fixing points instead of the conventionally one fixing point, so as to provide a better writing comfort to the user.

Another object of the present invention is to provide an illuminable writing instrument, wherein no expensive or complicated structure is required to employ in the present invention in order to achieve the above mentioned objects. Therefore, the present invention successfully provides an economic and efficient solution not only for providing an enhanced illuminating effect to enhance the aesthetic appearance of the writing instrument but also for facilitating the practical use of the writing instrument.

Accordingly, in order to accomplish the above objects, the present invention provides an illuminable writing instrument, comprising:
a hollow writing unit holder having a first end, an opposing second end, a receiving cavity defining between the first and second ends, and a battery cavity provided at the second end of the writing unit holder for receiving a power source therein;
a writing unit, which is disposed in the receiving cavity of the writing unit holder, having a writing end extended out of the first end of the writing unit holder and a retaining end extended towards to the second end of the writing unit holder; and
an illumination arrangement, comprising:
a light dispersing cone, which is supported within the receiving cavity of the writing unit holder, having a cone vertex pointing towards the second end of the writing unit holder;
an illuminating unit, which is adapted for electrically connecting to the power source, comprising an illuminator supported within the receiving cavity at a position right above the cone vertex of the light dispersing cone; and
a control switch which is mounted at the second end of the writing unit holder and is electrically connected to the illuminating unit to activate the illuminator for providing an illuminating effect towards the cone vertex of the light dispersing cone, such that the light dispersing cone is adapted for vividly dispersing the illuminating effect towards the first end of the writing unit holder.

These and other objectives, features, and advantages of the present invention will become apparent from the following detailed description, the accompanying drawings, and the appended claims.

### BRIEF DESCRIPTION OF THE DRAWINGS

FIG. 1 is an exploded perspective view of an illuminable writing instrument according to a preferred embodiment of the present invention.

FIG. 2 is a sectional view of the illuminable writing instrument according to the above preferred embodiment of the present invention.

### DETAILED DESCRIPTION OF THE PREFERRED EMBODIMENT

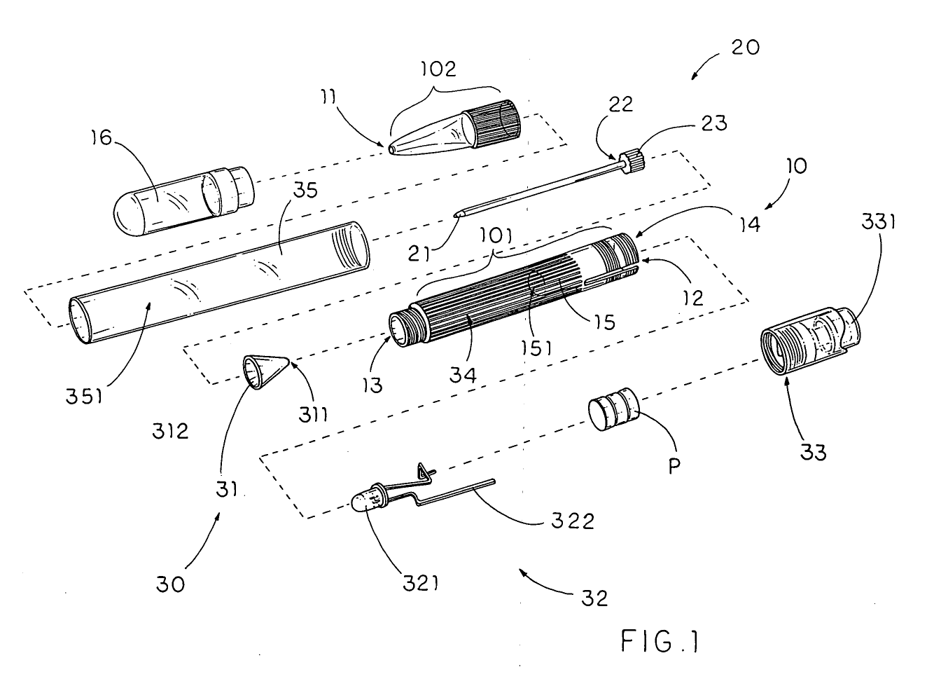

Referring to FIG. 1 of the drawings, an illuminable writing instrument according to a preferred embodiment of the present invention is illustrated, wherein the illuminable writing instrument comprises a hollow writing unit holder 10, a writing unit 20, an illumination arrangement 30.

The hollow writing unit holder 10 has a first end 11, an opposing second end 12, a receiving cavity 13 defining between the first and second ends 11, 12, and a battery cavity 14 provided at the second end 12 of the writing unit holder 10 for receiving a power source P therein.

The writing unit 20, which is disposed in the receiving cavity 13 of the writing unit holder 10, has a writing end 21 extended out of the first end 11 of the writing unit holder 10 and a retaining end 22 extended towards to the second end 12 of the writing unit holder 10.

The illumination arrangement 30 comprises a light dispersing cone 31, which is supported within the receiving cavity 13 of the writing unit holder 10, having a cone vertex 311 pointing towards the second end 12 of the writing unit holder 10, and an illuminating unit 32, which is adapted for electrically connecting to the power source P, comprising an illuminator 321 supported within the receiving cavity 13 at a position right above the cone vertex 31 of the light dispersing cone 31 for producing light.

The illumination arrangement 30 further comprises a control switch 33 which is mounted at the second end 12 of the writing unit holder 10 and is electrically connected to the illuminating unit 32 to activate the illuminator 321 for providing the light towards the cone vertex 311 of the light dispersing cone 31, such that the light dispersing cone 31 is adapted for vividly dispersing the light towards the first end 11 of the writing unit holder 10 so as to enhance the illuminating effect of the illuminable writing instrument.

According to the preferred embodiment, the writing unit holder 10 is an elongated hollow member made of lightweight and transparent material such as plastic so as to substantially reduce the overall weight of the illuminable writing instrument of the present invention.

As shown in FIG. 1, the writing unit holder 10 comprises a tubular holder body 101 and a holder head 102 detachably attached to the holder body 101 for replacing the writing unit 20. Accordingly, the holder body 101 has an outer threaded portion to rotatably engage with an inner threaded portion of the holder head 102 to detachably attach the holder body 101 to the holder head 102 to form the writing unit holder 10.

The writing unit 20, according to the preferred embodiment, is a ink cartridge tube defining the writing end 21 extended out of the first end 11 of the writing unit holder 10 and the retaining end 22 extended towards the second end 12 of the writing unit holder 10 to a position below of the light dispersing cone 31. The writing unit 20 further comprises a retaining member 23 attached to the retaining end 22 of the writing unit 20 to bias against the inner surface of the writing unit holder 10 below the light dispersing cone 31 so as to retain the writing unit 20 within the receiving cavity 13 of the writing unit holder 10 in position. Accordingly, the retaining member 23 has a cog-liked cross section to define the light guiding passage for guiding the light to disperse on the writing unit holder 10.

The writing unit holder 10 further comprises a transparent holder cap 16 detachably affixed to the first end 11 of the writing unit holder 10 to enclose the writing end 21 of the writing unit 20.

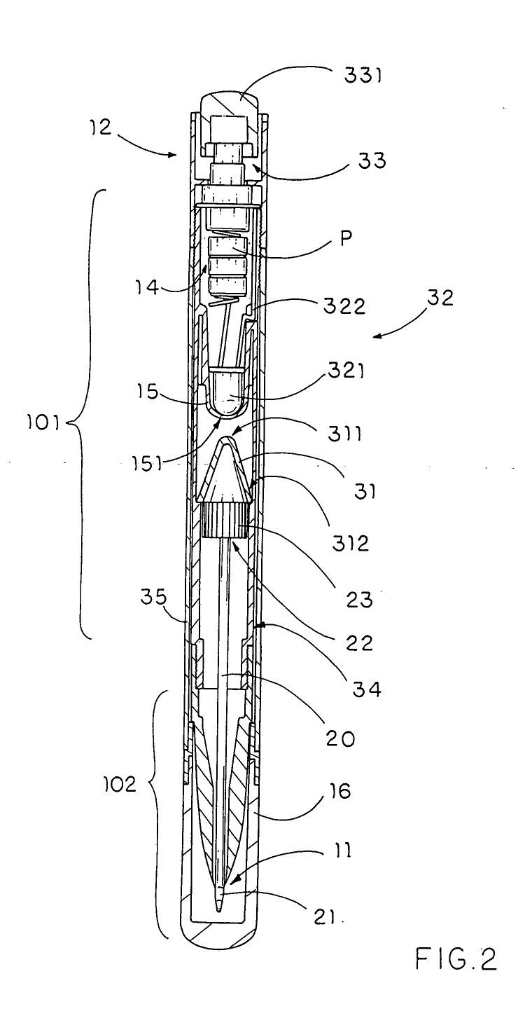

As shown in FIGS. 1 and 2, the light dispersing cone 31 is made of transparent material such as plastic wherein the light dispersing cone 31 is coaxially affixed to the writing unit holder 10 by securely affixing a cone edge 312 of the light dispersing cone 31 to an inner surface of the holder body 101 of the writing unit holder 10. In other words, the overall weight of the illuminable writing instrument can be substantially reduced in comparison with the solid writing unit holder with integral cone shaped receiving cavity. Therefore, the configuration of the writing unit holder 10 not only substantially minimizes the material cost of the illuminable writing instrument but also simplifies the structure of the writing unit holder 10 incorporating with the light dispersing cone 31.

Accordingly, the light dispersing cone 31 is supported within the receiving cavity 13 of the writing unit holder 10 at a position that the cone vertex 311 is pointing towards the illuminator 321 such that when the illuminator 321 is activated to produce light towards the cone vertex 311 of the light dispersing cone 31, the light dispersing cone 31 is adapted for physically dispersing the light towards the first end 11 of the writing unit holder 10 so as to enhance the illuminating effect of the illuminable writing instrument of the present invention.

As shown in FIG. 2, the writing unit holder 10 further comprises a magnifying lens 15 supported within the receiving cavity 13 at a position between the illuminator 321 and the cone vertex 311 of the light dispersing cone 31, wherein the magnifying lens 15 has a transparent convex-concave surface 151 aligned with the illuminator 321 for directly magnifying the light from the illuminator 321 to the cone vertex 311 of the light dispersing cone 31.

The illumination unit 32, which is disposed in the receiving cavity 13 of the writing unit holder 10 at the second end 12 thereof, further comprises an electric terminal 322 electrically extended from the illuminator 321 to the control switch 33 in such a manner that when the control switch 33 is actuated to electrically connect the electric terminal 322 with the power source P, the illuminator 321 is activated for producing the illuminating effect.

According to the preferred embodiment, the power source P is embodied as a replaceable battery disposed in the battery cavity 14 of the writing unit holder 10 to electrically connect with the illuminator 321.

The illuminator 321 is embodied as a LED coaxially supported within the receiving cavity 13 of the writing unit holder 10 at a center thereof wherein the illuminator 321 is positioned right above the cone vertex 311 of the light dispersing cone 31 for generating the illuminating effect. It is worth to mention that the illumination unit 32 requires only one LED as the illuminator 321 that enough to provide the illuminating effect for the illuminable writing instrument since the light from the LED of the illumination unit 32 is effectively guided to diffuse throughout the writing unit holder 10.

The control switch 33 comprises an actuating button 331 slidably mounted at the second end 12 of the writing unit holder 10 in a vertically movable manner wherein the actuating button 331 is depressed to electrically connect the illuminator 321 with the power source P so as to activate the illuminator 321 to produce the illuminating effect. Accordingly, the illumination operation of the illumination arrangement 30 is individual such that the illuminable writing instrument is adapted to perform a normal writing function without the need of the operation of the illumination arrangement, so as to provide a longer life span of the illumination arrangement.

As shown in FIG. 2, the illumination arrangement 30 further has a plurality of light guiding channels 34 spacedly and longitudinally provided on the writing unit holder 10 to extend towards the first end 11 thereof for substantially guiding the light dispersed from the illuminator 321 towards the first end 11 of the writing unit holder 10 so as to further enhance the illuminating effect of the illuminable writing instrument.

The light guiding channels 34 are spacedly formed on an outer surface of the writing unit holder 10 such that each of the light guiding channels 34 is adapted for reflectively guiding the light from the illuminator 321 towards the first end 11 of the writing unit holder 10.

The illumination arrangement 30 further comprises a transparent tubular light enhancing shelter 35, having an outer smooth holding surface 351, coaxially receiving the writing unit holder 10 therewithin to cover the light guiding channels 34 for evenly diffusing the light along the light guiding channels 34 in a three-dimension manner. Accordingly, since the light guiding channels 34 are indented on the outer surface of the writing unit holder 10, it is discomfortable for the user to use the illuminable writing instrument while holding the writing unit holder 10. Therefore, the light enhancing shelter 35 not only enhances the light diffusion along the light guiding channels 34 but also provides the smooth holding surface 351 for the user while using the illuminable writing instrument of the present invention.

It is worth to mention that the light guiding channels 34 can be formed at the inner surface of the writing unit holder 10 while the outer surface of the writing unit holder 10 can be defined as the smooth holding surface 351. However, by incorporating with the light enhancing shelter 35, the illuminable writing instrument can provide a stronger illuminating effect with three-dimension manner.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

1. An illuminable writing instrument, comprising:
a hollow writing unit holder having a first end, a second end, a receiving cavity defined between said first and second ends, and a battery cavity provided at said second end of said writing unit holder for receiving a power source therein;
a writing unit, which is disposed in said receiving cavity of said writing unit holder, having a writing point extended to said first end of said writing unit holder and a retaining end extended towards said second end of said writing unit holder; and
an illumination arrangement, comprising:
a light dispersing cone, which is supported within said receiving cavity of said writing unit holder, having a cone vertex pointing towards said second end of said writing unit holder;
an illuminating unit, which is adapted for electrically connecting to said power source, comprising an illuminator mounted in said receiving cavity at a position right above said cone vertex of said light dispersing cone for producing illuminating light; and
a control switch provided on said writing unit holder and electrically connected to said illuminating unit to activate said illuminator for providing said illuminating light towards said cone vertex of said light dispersing cone, such that said light dispersing cone is adapted for vividly dispersing said illuminating light towards said first end of said writing unit holder so as to enhance an illuminating effect of said illuminable writing instrument.

2. The illuminable writing instrument, as recited in claim 1, wherein said illumination arrangement further has a plurality of light guiding channels spacedly and longitudinally provided on said writing unit holder, wherein each of said light guiding channels is extended towards said first end of said writing unit holder for substantially guiding said illuminating light dispersed from said illuminator towards said first end of said writing holder.

3. The illuminable writing instrument, as recited in claim 2, wherein said illumination arrangement further comprises a transparent tubular light enhancing shelter, having an outer smooth holding surface, coaxially receiving said writing unit holder therewithin to cover said light guiding channels for evenly diffusing said illuminating light along said light guiding channels in a three-dimension manner.

4. The illuminable writing instrument, as recited in claim 3, wherein said light guiding channels are spacedly formed on an outer surface of said writing unit holder to communicate with said illuminating light enhancing shelter.

5. The illuminable writing instrument, as recited in claim 1, wherein said light dispersing cone has a cone edge securely affixed to an inner surface of said holder body to align said vertex of said light dispersing cone to said illuminator.

6. The illuminable writing instrument, as recited in claim 2, wherein said light dispersing cone has a cone edge securely affixed to an inner surface of said holder body to align said vertex of said light dispersing cone to said illuminator.

7. The illuminable writing instrument, as recited in claim 3, wherein said light dispersing cone has, a cone edge securely affixed to an inner surface of said holder body to align said vertex of said light dispersing cone to said illuminator.

8. The illuminable writing instrument, as recited in claim 4, wherein said light dispersing cone has a cone edge securely affixed to an inner surface of said holder body to align said vertex of said light dispersing cone to said illuminator.

9. The illuminable writing instrument, as recited in claim 1, wherein said writing unit holder further comprises a magnifying lens supported within said receiving cavity at a position between said illuminator and said cone vertex of said light dispersing cone, wherein said magnifying lens has a transparent convex-concave surface aligned with said illuminator for directly magnifying said illuminating light from said illuminator to said cone vertex of said light dispersing cone.

10. The illuminable writing instrument, as recited in claim 3, wherein said writing unit holder further comprises a magnifying lens supported within said receiving cavity at a position between said illuminator and said cone vertex of said light dispersing cone, wherein said magnifying lens has a transparent convex-concave surface aligned with said illuminator for directly magnifying said illuminating light from said illuminator to said cone vertex of said light dispersing cone.

11. The illuminable writing instrument, as recited in claim 5, wherein said writing unit holder further comprises a magnifying lens supported within said receiving cavity at a position between said illuminator and said cone vertex of said light dispersing cone, wherein said magnifying lens has a transparent convex-concave surface aligned with said illuminator for directly magnifying said illuminating light from said illuminator to said cone vertex of said light dispersing cone.

12. The illuminable writing instrument, as recited in claim 8, wherein said writing unit holder further comprises a magnifying lens supported within said receiving cavity at a position between said illuminator and said cone vertex of said light dispersing cone, wherein said magnifying lens has a transparent convex-concave surface aligned with said illuminator for directly magnifying said illuminating light from said illuminator to said cone vertex of said light dispersing cone.

13. The illuminable writing instrument, as recited in claim 2, wherein said writing unit further comprises a retaining member attached to said retaining end of said writing unit to bias against an inner surface of said writing unit holder at a position below said illuminating light dispensing cone so as to retain said writing unit within said receiving cavity of said writing unit holder in position.

14. The illuminable writing instrument, as recited in claim 4, wherein said writing unit further comprises a retaining member attached to said retaining end of said writing unit to bias against an inner surface of said writing unit holder at a position below said illuminating light dispensing cone so as to retain said writing unit within said receiving cavity of said writing unit holder in position.

15. The illuminable writing instrument, as recited in claim 8, wherein said writing unit further comprises a retaining member attached to said retaining end of said writing unit to bias against an inner surface of said writing unit holder at a position below said illuminating light dispensing cone so as to retain said writing unit within said receiving cavity of said writing unit holder in position.

16. The illuminable writing instrument, as recited in claim 12, wherein said writing unit further comprises a retaining member attached to said retaining end of said writing unit to bias against an inner surface of said writing unit holder at a position below said illuminating light dispensing cone so as to retain said writing unit within said receiving cavity of said writing unit holder in position.

17. The illuminable writing instrument, as recited in claim 4, wherein said illuminator comprises a LED coaxially supported within said receiving cavity of said writing unit holder at a center thereof to align with said cone vertex of said light dispersing cone.

18. The illuminable writing instrument, as recited in claim 8, wherein said illuminator comprises a LED coaxially supported within said receiving cavity of said writing unit holder at a center thereof to align with said cone vertex of said light dispersing cone.

19. The illuminable writing instrument, as recited in claim 12, wherein said illuminator comprises a LED coaxially supported within said receiving cavity of said writing unit holder at a center thereof to align with said cone vertex of said light dispersing cone.

20. The illuminable writing instrument, as recited in claim 16, wherein said illuminator comprises a LED coaxially supported within said receiving cavity of said writing unit holder at a center thereof to align with said cone vertex of said light dispersing cone.
